(19) United States
(12) Patent Application Publication
(10) Pub. No.: US 2015/0379633 A1
(43) Pub. Date: Dec. 31, 2015

(54) Implied Volatility Futures Product

(71) Applicant: Chicago Mercantile Exchange Inc., Chicago, IL (US)

(72) Inventors: John Kerpel, Chicago, IL (US); John Labuszewski, Westmont, IL (US); John Nyhoff, Darien, IL (US); Richard Co, Chicago, IL (US); Lori Aldinger, Naperville, IL (US)

(21) Appl. No.: 14/317,585

(22) Filed: Jun. 27, 2014

(51) Int. Cl. G06Q 40/04

(52) U.S. Cl. CPC G06Q 40/04

(57) ABSTRACT

Systems and methods are described for providing a derivatives product corresponding to an implied volatility of a financial product traded on an exchange. The method may include calculating, by one or more computing devices, a risk neutral density based on options information associated with an option trading on a financial market. The one or more computing devices may calculate an implied volatility associated with the option based on the risk neutral density and provide an implied volatility derivatives product corresponding to implied volatility of a financial product underlying the option, wherein the derivatives product is cash-settled based on the implied volatility.

### BACKGROUND

In some cases, traders, or other investors, may desire to invest using a strategy based on a volatility seen in a financial marketplace. Currently, only limited options are available to these traders. For example, a trader may invest in options using a strategy involving a delta-hedged straddle or by investing in a traded volatility options product, such as a Chicago Board Options Exchange (CBOE) Market Volatility Index (VIX) futures product, a volatility index futures product (VSTOXX) offered via the Eurex Exchange, an implied volatility futures product (VDAX) offered via the Deutscher Aktien Index (DAX), and/or the like.

Options may be a popular investment vehicle due to a strictly limited associated risk, at least for an options buyer. In general, an options buyer may pay a cost of the option, known as the premium, upfront and in cash. Once paid, that premium represents the maximum possible loss to which the option buyer may be exposed. In many cases, options may be combined in different ways. For example, combinations of options may allow for different types of speculation and/or hedging. One such method is to buy (or sell) a call and a put, each having the same strike price and maturity. This combination may be referred to as a straddle. Straddles can be used to bet on large price movements of the product that underlies the option (e.g., the underlier). The bet may pay off when the underlier moves substantially in either direction. As such, a straddle may be considered to be a “play” on implied volatility.

A straddle is considered to be “at-the-money” when the strike price of the call equals the strike price of the put. A positive delta (e.g., a price difference) of the call may offset any negative delta of the put. As such, a straddle struck at-the-money has a net delta of zero. In such cases, when the net delta of the straddle is zero, the straddle position does not need to be delta hedged. In other words, no trades of the underlying product (e.g. a futures product) would need to be made against the straddle to keep the straddle position delta neutral. However, for those straddles that are not at-the-money, the net delta may be positive or negative. A positive delta may require the trader to delta hedge the position by selling enough futures to equal the value of the net delta. An important aspect of a delta-hedged straddle is to keep the position delta hedged so that any directional changes in the underlying product may be nullified. For example, in cases where the straddle is not delta hedged, the trader has not effectively isolated the volatility component of the straddle. As such, the trader may then face delta exposure. Over time, the delta associated with a straddle may change. For example, a straddle that may be at-the-money (e.g., zero net delta) on one particular day may be delta positive (or delta negative) on a subsequent day. As such delta hedging may be considered to be a continuous process to maintain the delta neutral status of the straddle.

Delta-hedged straddles may be costly to implement and/or difficult to continuously delta hedge. For example, because an option premium is paid upfront and in cash, delta hedging may represent a significant opportunity cost for the straddle buyer. In some cases, a significant component of the option premium is known as “time value.” An option may be considered to be analogous to an insurance policy. For an insurance policy, a longer term may result in a greater cost of insurance and/or a greater cost of the insurance premium. Similarly, an option having a longer term, holding other variables constant, increases the premium of the option accordingly. As such, option buyers are often reluctant to purchase expensive, longer-term options. However, they may still wish to secure the benefits of those options. As such, it would be desirable to provide a way to provide a financial product having a clear quoting convention in volatility points and which may provide a high degree of customization.

### SUMMARY

Systems and methods are described for providing a derivatives product corresponding to an implied volatility of a financial product traded on an exchange. The method may include calculating, by one or more computing devices, a risk neutral density based on options information associated with an option trading on a financial market. The one or more computing devices may calculate an implied volatility associated with the option based on the risk neutral density and provide an implied volatility derivatives product corresponding to implied volatility of a financial product underlying the option, wherein the derivatives product is cash-settled based on the implied volatility. In some cases, the method may include obtaining, such as by one or more computing devices, the options information from the financial market and/or a financial exchange, where the options information may include at least one of the options price, a term, a risk free rate, a dividend yield, and a current price of the underlying financial product.

In some cases, a non-transitory computer readable medium may store instructions that, when executed, may cause at least one computing device to provide an implied volatility derivatives product. For example, the instructions may cause the at least one computing device to receive, via a network, options information associated with an option trading on a financial market. The options information may include at least a price (e.g., a current price, a strike price, etc.) and a term to expiry and calculate a risk neutral density based on the options information. In some cases, the risk neutral density may be calculated using a technique providing a best fit for the options information. The instructions may further cause the at least one computing device to determine a price of an implied volatility derivatives product, the implied volatility derivatives product corresponding to implied volatility associated with the underlying financial product. The price may be calculated as a function of an implied volatility derived from the risk neutral density. In some cases, the instructions, when executed, cause the at least one computing device to identify the option on the financial exchange. The option may have a first maturity date associated with the term to expiry. In some cases, the instructions may further cause the at least one computing device to collect, at a first time, first pricing information associated with the option, wherein the option expires at the maturity date and to collect, at a second time subsequent to the first time, second pricing information corresponding to the option that expires at the maturity date.

A system for providing one or more implied volatility derivatives products associated with an option traded on a financial exchange may include one or more computing devices and at least one non-transitory memory device communicatively coupled to the one or more computing devices. In some cases, the system may further include a communications interface to communicatively couple the at least one computing devices to an exchange computing system. The at least one non-transitory memory device may store instructions that, when executed by a processor, cause the one or more computing devices to obtain options information corresponding to an option trading at a financial exchange. The options information may be received at each of a plurality of times over a time period. Further, the options information may include at least a market price, a strike price, a term to expiry, and a price of an underlier of the option. In some cases, the instructions may further cause the one or more computing devices to calculate a risk neutral density based on the options information for each of the plurality of times and determine a strike price associated with each risk neutral density at each of the plurality of times. The strike price may be within a range of prices that includes a market price of the option. The computing device may then calculate an implied volatility based on the strike price at each of the plurality of times, and calculate a price of an implied volatility product at each of the plurality of times, the price calculated based on the implied volatility.

The details of these and other embodiments of the present invention are set forth in the accompanying drawings and the description below. Other features and advantages of the invention will be apparent from the description and drawings.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an illustrative trading network environment for implementing trading systems and methods according to at least some embodiments.

FIG. 2 shows a portion of an illustrative system for providing and pricing an implied volatility derivatives product associated with an option traded on a financial exchange in accordance with an aspect of the invention.

FIG. 3 shows an illustrative flow diagram 300 of a method for providing and pricing an implied volatility derivatives product in accordance with an aspect the invention.

FIG. 4 shows an illustrative risk neutral density chart in accordance with an aspect of the invention.

### DETAILED DESCRIPTION

In some cases, a financial institution may desire to offer a financial product based on volatility of an underlying product. For example, a derivative or futures contract may be offered, where the derivative or futures contract may be cash-settled based on implied volatility calculated from a risk neutral density (RND) from option prices. In doing so, the derivative or futures contract becomes an implied volatility product. This implied volatility derivatives product may eliminate costs associated with delta-hedged straddles, allow for more diversity in implied volatility products available to the public, and/or provide a clear quoting convention in volatility points. The implied volatility derivatives product may offer a high degree of customization because the user can base the risk neutral density on any traded option series (providing a flexible term structure) and/or for a wide range of “moneyness”, that is not constrained to a preset strike interval.

In the financial industry, the term “variable moneyness” refers to a degree that an option is in-the-money, or out-of-the-money. Moneyness may be used to describe an intrinsic value of an option and may be computed as a ratio of strike price to the current price of an underlier of the option. For example, moneyness may be computed using the formula moneyness=K/S, where K is the strike price and S is the current price of the underlier. For example, if an option has a strike price of K=1700 and its underlier has a current price of S=1700, then moneyness may be calculated as K/S=1700/1700=1.00 or 100%. A moneyness of 100% is also known as being “at-the-money” (ATM). If the strike price of the option is K=1785 and the current price of its underlier is S=1700, then moneyness=K/S=1.05 or 105%, which is “out-of-the-money”. Similarly if the strike price of the option is K=1615 and the current price of its underlier is S=1700, then moneyness=K/S=0.95 or 95%, which is “in-the-money”. Moneyness may also be used to describe a value of an option if exercised. For example, a loss may signify that an option is out-of-the-money, while a gain may be considered “in-the-money”. When an option is at-the-money, the option is at a break-even price.

As mentioned above, a financial entity (e.g., a financial exchange) may desire to provide a product representative of an implied volatility associated with a particular underlying financial product (e.g., an underlier). In doing so, the implied volatility associated with the underlier may be determined using information from one or more different sources, such as information about an option associated with the underlier. This options information may be obtained from a financial exchange, or other source of financial information and may include at least one or more of a market price of the option, a strike price of the option, a term to expiry, a risk free rate, a dividend yield (if applicable), and a current price of the underlying product. Once obtained, a computing device associated with the financial exchange may apply one or more different risk neutral density techniques to determine a risk neutral density corresponding to an underlying risk neutral (or risk adjusted) probabilities of returns implied by option prices. Different techniques may be used to determine the risk neutral density from quoted option prices, such as by using Shimko's method, an Edgeworth expansion, a mixture of lognormals, Figlewski's method, and others. These techniques may also be used to give more accurate prices for options that are out-of-the-money (e.g., in the tails of the distribution) as these out-of-the-money options have little or no market activity. In some cases, the choice of which method to be used may be determined by determining which method best fits the provided data set. In some cases, the choice of methods may be determined by the underlier type. For example, a first method may provide a more accurate risk neutral density for treasuries, while a different method may better fit an equities based option.

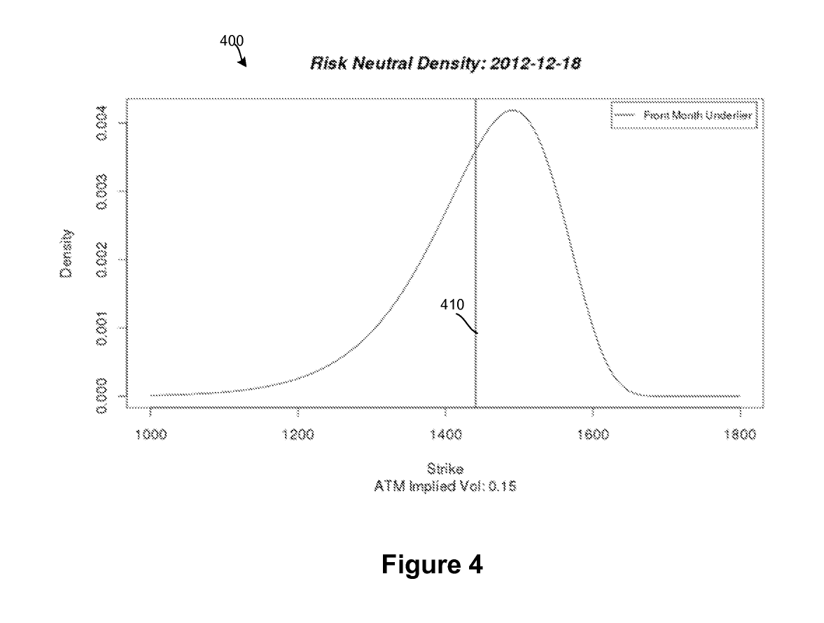

The risk neutral density may be determined over a range of strike prices to build a complete density function, such as the chart illustrated in FIG. 4. This risk neutral density may be considered a function of strike price only, rather than a function of strike prices and implied volatility because the volatility part may have been estimated via a quadratic polynomial function that spans the strike range. From this risk neutral density, one or more prices may be estimated, such as a put price and/or a call price. In some cases, the put price and/or the call price may be estimated to be at-the-money (e.g., 100% moneyness). In other cases, put price and/or the call price may be estimated to be out-of-the-money (e.g., greater than or less than 100% moneyness). Using the estimated put price and/or the estimated call price, an implied volatility may be computed using an inversion of a pricing model, such as an inversion of Black-Scholes, or other such pricing model. In some cases, the financial entity may desire to quote a price of the implied derivatives product in “volatility points”. In other words, the price of the implied volatility derivatives product may be calculated using the implied volatility calculated based on the risk neutral density.

Exemplary Operating Environment

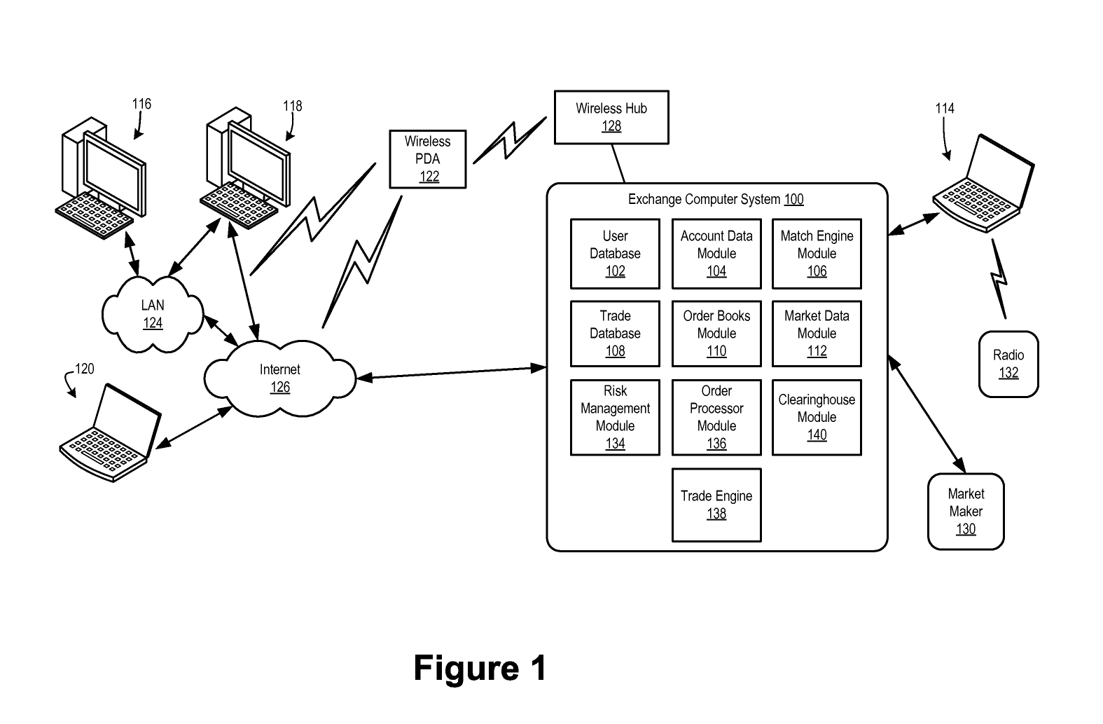

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses one or more 64-bit processors. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell a financial product with a bid by party B to purchase a like financial product. Module 140 may then create a financial product between party A and the exchange and an offsetting second financial product between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a Ti line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In some cases, the exchange computing system 100 may be configured to create and/or price an implied volatility derivative product based on an implied volatility of an underlying financial product. In at least some embodiments, the exchange computer system 100 (or “system 100”) receives, stores, generates and/or otherwise and processes data. In accordance with various aspects of the invention, the exchange computing system 100 may obtain pricing information corresponding to the underlying financial product from a financial market. This may promise a more straight-forward way for investors to take a position based on implied volatility of a financial product.

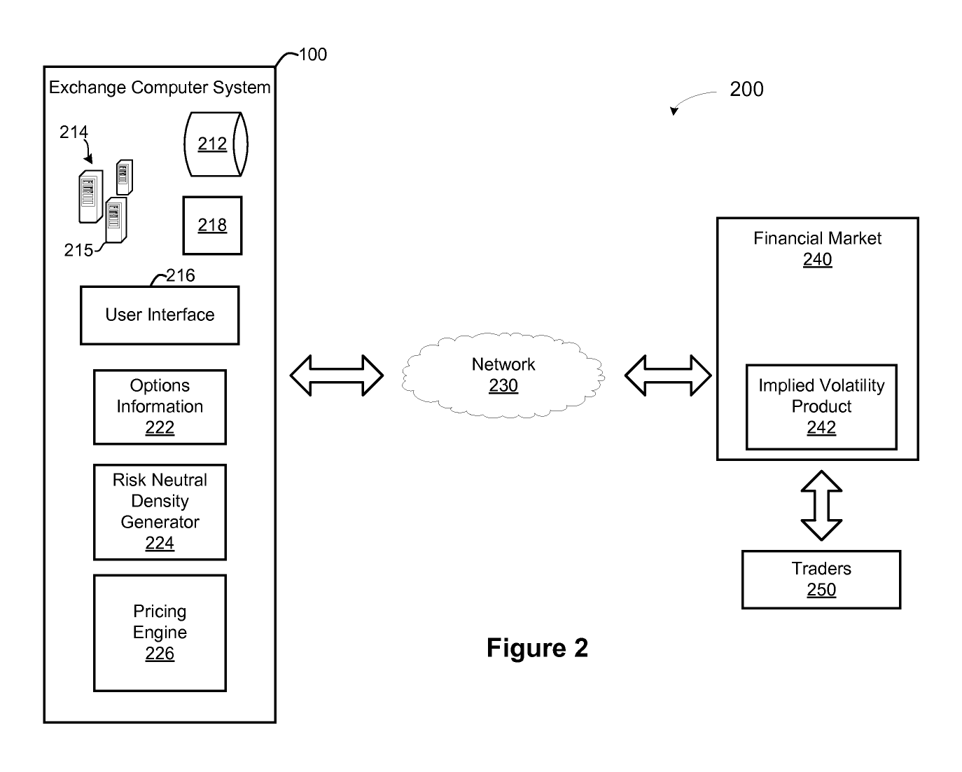

FIG. 2 shows a portion of an illustrative system 200 for creating and/or managing a financial product based on volatility of an underlying product in accordance with an aspect of the invention. In some cases, the illustrative system 200 may include an exchange computing system 100 communicatively coupled to a financial market 240 via a network 230 (e.g., a wide area network (WAN), the LAN 124, the Internet 126, etc.). The exchange computing system 100 may include a data repository 212, one or more computing devices 214, and, in some cases, at least one user interface 216. In some cases, a financial exchange may desire to provide an implied volatility product 242 to traders 250 via the financial market 240. The implied volatility product 242 may be based on an implied volatility calculated based on information of a financial product (e.g., an option) that may also be traded via one or more financial markets, such as the financial market 240. In some cases, an underlying financial product associated with the implied volatility product 242 may include a stock futures contract, a bond futures contract, a commodity futures contract, a currency futures contract, and the like.

In some cases, a user of the exchange computer system 100 may select a particular option for use in creating an implied volatility derivative product, such as via the user interface 216. In other cases, a computing device 215 may process instructions stored in the data repository, to process trading information obtained from the financial market to determine which underlying financial product(s) may be used to create the implied volatility derivative product that may be marketable to a particular class or group of the traders 250. For example, the computing device 215 may process trading information to determine that a particular implied volatility derivatives product (e.g., the implied volatility product 242) may be likely to have a larger target market of traders 250 than another.

Once an option product has been selected, at least one computer device 215 may query, or otherwise receive information about the option including, but not limited to a market price of the option, a strike price of the option, a term to expiry of the option, a maturity date (e.g., expiration date) of the option, a risk free rate, a dividend yield (if applicable), and/or a current price of the underlying financial product. This information may be stored in the data repository 212, or other memory device, for use in generating a risk neutral density associated with the option and/or the underlier of the option. In some cases, at least a portion of the options information may be used when determining a price of the implied volatility product 242. The computing device 215 may be configured to obtain the options information 222 nearly continuously. In other cases, the options information 222 may be obtained upon expiry of a specified time period (e.g., about 250 milliseconds, about 1 second, about 1 minute, about 1 hour, about 1 day, etc.). For example, the computing device 215 may be configured to obtain the options information from the financial market 240 on a nearly continuous basis, such that the information may be sampled at a rate selected such that a price of the implied volatility product 242 may be updated on a nearly continuous basis.

Once the options information 222 is available, at least one computing device 215 may then calculate a risk neutral density associated based on the options information, such as by using a risk neutral density generator 224. In some cases, the risk neutral density generator 224 may be configured to calculate the risk neutral density using a specified method (e.g., Shimko's method, Figlewski's method, etc.). Other times, the risk neutral density generator 224 may be configured to evaluate which one, of a number of methods, may best fit the options information 222 obtained from the financial market 240. For example, the risk neutral density generator 224 may be configured to compute a risk neutral density for a particular sample of the options information 222 using a number of different methods, such as Shimko's method, an Edgeworth expansion, a mixture of lognormals, Figlewski's method, and the like. Once computed, the resulting risk neutral density may be evaluated to determine which one(s) of the methods provides a best fit for the available data set. In some cases, the computing device 215 may evaluate the risk neutral densities automatically. In other cases, different ones of the calculated risk neutral densities may be presented to a user via the user interface 216 for evaluation, where a user may select the method providing the best fit to the available data. In some cases, this evaluation may be performed before an introduction of a new implied volatility product 242 and/or at times during over the lifetime of the implied volatility product 242 to ensure accuracy and/or consistency of the pricing.

After a risk neutral density has been calculated, at least one computing device may be configured to compute a price of the implied volatility product 242, such as by using a pricing engine 226. The pricing engine 226 may determine at least one of a put price and a call price based on the risk neutral density. In some cases, these prices may be determined based on a specified level of moneyness associated with the strike price of the option and the market price of the underlier. For example, the price (e.g., the call price and/or the put price) may be selected as an at-the-money price, where the strike price of the option is equal to the market price of the underlier. In some cases, this at-the-money price may not be a tradable price in the market. For example, an options exchange may limit prices of options to an integer value. In some cases, the integer value may be incremented in steps greater than 1. For example, an option price may be incremented by 5 (e.g., 1800, 1805, 1810, etc.). In some cases, the at-the-money price may be a price (e.g., 1802.23) where no options may be struck. In such cases, the pricing engine 226 may be able to determine a price of the option, even though the option cannot be traded at that price. By doing so, the option price (e.g., put price, call price, etc.) may be frequently updated by the pricing engine 226, such as by determining the price at the expiration of a specified time or at a specified update rate of the options prices. For example, the pricing engine 226 may be configured to determine the price at a rate specified to provide pricing information in a nearly continuous manner.

Once an option price has been determined based on the risk neutral density, the pricing engine 226 implemented by at least one computing device 215 may be configured to determine an implied volatility associated with the risk neutral density. For example, the pricing engine 226 may calculate the implied volatility using the option price (e.g., the put price and/or the call price) determined using the risk neutral density using a pricing formula. In some cases, the implied volatility may be calculated based on the determined options price using an inversion of the Black-Scholes formula, wherein the implied volatility is the volatility implied by the price determined using the risk neutral density. Again, the pricing engine 226 may be configured to frequently update the implied volatility, such as by determining the implied volatility at the expiration of a specified time or at a specified update rate of the options prices and/or the determined put price or call price. For example, the pricing engine 226 may be configured to determine the implied volatility at a rate configured to provide an implied volatility updated in a nearly continuous manner. In some cases, the implied volatility may be presented as a percentage (e.g., 1.3%, 11.3%, etc.).

Using the calculated implied volatility, the pricing generator 226 may be configured to determine a price (e.g., a market price) at which the implied volatility product 242 is offered to the traders 250 via the financial market 240. In some cases, this market price may be calculated as a function of the implied volatility as determined by the pricing generator 226. For example, the market price of the implied volatility product 242 may be calculated by multiplying the implied volatility by a multiplier (e.g., market price=(implied volatility)*(multiplier). In some cases, the multiplier may be a constant value (e.g., an integer). In some cases, the multiplier may correspond to a price (e.g., a strike price of the option, a market price of the underlier, a put/call price determined from the risk neutral density, etc.) used during the pricing calculation over the particular pricing interval. In some cases, the pricing formula may include an additional marginal amount combined with a product determined using the implied volatility. For example, the pricing formula may be defined as market price=(implied volatility)*(multiplier)+(marginable amount). In an illustrative example, the implied volatility may be calculated to be 16.5% based on a risk neutral density calculated using on a strike price of 1804.23. In this example, the pricing engine 226 may be configured to using the formula: market price=(implied volatility)*(multiplier)+(5%)*(implied volatility)*(multiplier), such that the price of the implied volatility product 242 for this time period would be equal to (16.5%)*(1804.23)+(5%)*((16.5%)*(1804.23))=$312.58. Over time, the pricing engine 226 may be configured to frequently update the price of the implied volatility product 242, such as at the expiration of a specified time or at a specified update rate of the options prices. For example, the pricing engine 226 may be configured to determine the price of the implied volatility product 242 at a rate so that the price is updated in a continuous or nearly continuous manner.

As discussed above, at least one computing device 215 may be configured to create and/or manage one or more different implied volatility derivative products based on an option and representative of the implied volatility of the underlying product. In some cases, the computing devices 214 may be configured to create and/or manage two or more different implied volatility products based on an option having a same underlying financial product. In some cases, two or more different risk neutral densities may be determined, each based on an option having a different term to expiry. For example, the options information 222 may include a group of options, each having a different term to expiry. For example, the group of options may include a 30 day option, a 60 day option, a 90 day option, and/or the like. The at least one computing device 215 may be configured to calculate a different risk neutral density for each option in the group of options, where a first risk neutral density may correspond to a first term to expiry (e.g., a 30 day term), a second risk neutral density may correspond to a second term to expiry (e.g., a 60 day term), a third risk neutral density may correspond to a third term to expiry (e.g., a 90 day term), and/or the like.

When different, each of the implied volatility products may correspond to the original term and the associated maturity date. For example, on a first day, a pricing engine 226 may provide a price of the implied volatility product 242 associated with a 60 day term to expiry. The price may correspond to an implied volatility of the underlying product over the 60 day term. The next day, the pricing engine 226 may provide a second price corresponding to an implied volatility of the underlying product over the next 59 days, the time remaining in the original term, and so on until the expiration date of the option.

In some cases, the at least one computing device 215 may be configured to create and/or manage one or more different implied volatility derivative products based over a range of moneyness, where the price of the products may be representative of the implied volatility of the underlying product of the option. In an illustrative example, the pricing engine 226 may compute a price for an implied volatility product 242, where the implied volatility may be calculated based on an at-the-money price representative of 100% moneyness. However, as discussed above, an option may not trade at 100% moneyness due to a number of reasons. For example, an option may trade at a price having an integer value, while the at-the-money price may be a non-integer value. As such, it may be desirable to use a price near the at-the-money price (e.g., within a defined range including the strike price) to determine the implied volatility value. For example, a strike price of the option may be an integer value, and the price of the underlier may be a different (e.g., a non-integer value). As such, the put price and/or call price determined from the risk neutral density may be different than the at-the-money price. As such, this put price and/or call price may be associated with a moneyness within a range including the at-the-money value. For example, the put price and/or call price may be within a range from about 90% moneyness to about 110% moneyness or within a range from about 95% moneyness to about 105% moneyness. In some cases, the range may be symmetrical about the at-the-money value, but this is not required. In some cases, the put price and/or call price determined from the risk neutral density may be at the tails of the risk neutral density. In some cases, two or more different call and/or put prices may be determined from the risk neutral density each having a different moneyness. Using the two or more call and/or put prices, two or more implied volatilities may be calculated to be used in pricing two or more different associated implied volatility products. In some cases, a group of implied volatility products associated with an option may include one or more implied volatility derivative products based on different terms of expiry, one or more implied volatility derivative products based on different degrees of moneyness, and/or one or more implied volatility derivative products based on both a different terms of expiry and different degrees of moneyness.

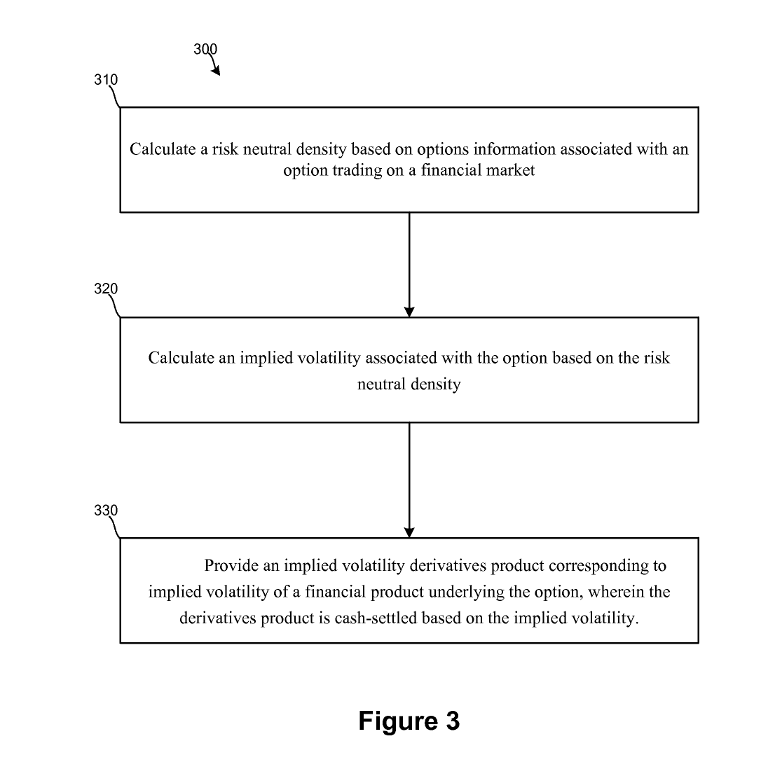

FIG. 3 shows an illustrative flow diagram 300 of a method for providing and pricing an implied volatility derivatives product in accordance with an aspect the invention. For example, at 310, one or more computing devices (e.g., the computing device 215) may be configured for calculating a risk neutral density based on options information associated with an option trading on a financial market. For example, the computing device 215 may obtain the options information from the financial market, the options information including at least one of the options price, a term, a risk free rate, a dividend yield, and a current price of the underlying financial product. In some cases, calculating the risk neutral density may include calculating the risk neutral density based on options prices associated with the option having a specified term and maturity date.

Once the risk neutral density has been calculated, at 320, the computing device 215 may calculate an implied volatility associated with the option based on the risk neutral density. For example, the computing device may identify a price (e.g., a put price and/or a call price) associated with the risk neutral density, wherein the price may be related to a strike price of the option. The computing device 215 may then calculate the implied volatility using at least one of the put price and the call price. In some cases, one or both of the put price and the call price may be calculated using an at-the-money strike price. In other cases, the put price and/or the call price may be calculated based on a price near the at-the-money price, such as a price within a range including the at-the-money strike price (e.g., a range from about 95% of the at-the-money price to about 105% of the at-the-money price). In some cases, the put price or the call price may be a price different than a tradable price in the financial market.

At 330, the computing device 215 may be configured to provide an implied volatility derivatives product (e.g., the implied volatility product 242), where the implied volatility product 242 corresponds to the implied volatility calculated in step 320. This implied volatility may be associated with the underlier of the option, and the implied volatility derivatives product may be cash settled based on the calculated implied volatility. In some cases, the computing device 215 may calculate the implied volatility and/or the price of the implied volatility derivatives product as a function of the implied volatility, over a specified time (e.g., the term to expiry of the option). In an illustrative example, the computing device may be configured to calculate a first price of the implied volatility derivatives product associated with a first time, where a first implied volatility is calculated using a first risk neutral density associated with the first time. The computing device 215 may then calculate a second price at a second time after the first time, where the second implied volatility may be calculated using a second risk neutral density associated with the second time. In this example, the first risk neutral density may correspond to options information obtained near the first time and the second risk neutral density may correspond to options information obtained near the second time.

FIG. 4 shows an illustrative risk neutral density chart 400 in accordance with an aspect of the invention. In some examples, such as in the illustrative chart 400, the implied volatility may be calculated at 100% moneyness or at-the-money. For example, chart 400 shows the risk neutral density calculated at an instant in time on a particular day (e.g., Dec. 18, 2012) and based on an option (e.g., option prices) having a 90 day term to expiry and a maturity date of Mar. 15, 2013. As can be seen, a price 410 may be chosen for use in calculating an implied volatility. In this case, the price 410 corresponds to a front month underlier (e.g., at-the-money) price of $1441.10, where the implied volatility may be calculated to be 15%. As can be seen, the price used to calculate the implied volatility may not be a tradable price, because the option may be traded at integer increments (e.g., 1440, 1441, 1445, etc.) on the financial exchange. In this example, the option struck at 1441.10 has an 87 day implied volatility of 15%, where these values may be used to calculate a price of an implied volatility product based on the option and/or the underlier of the option. These computations may be done at a very high frequency and therefore may provide the implied volatility product 242 to be priced in a nearly continuous manner.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims.

What is claimed is:

1. A method comprising:
calculating, by at least one computing device, a risk neutral density based on options information associated with an option trading on a financial market;
calculating, by the at least one computing device, an implied volatility associated with the option based on the risk neutral density; and
providing an implied volatility derivatives product corresponding to implied volatility of a financial product underlying the option, wherein the derivatives product is cash-settled based on the implied volatility.

2. The method of claim 1, comprising:
obtaining, by the at least one computing device, the options information from the financial market, the options information including at least one of an options price, a term, a risk free rate, a dividend yield, and a current price of the underlying financial product.

3. The method of claim 1, wherein calculating the risk neutral density includes calculating the risk neutral density based on options prices associated with the option having a specified term and maturity date.

4. The method of claim 1, comprising:
identifying a put price and a call price associated with the risk neutral density, wherein the put price and the call price are related to a strike price of the option; and
calculating the implied volatility using at least one of the put price and the call price.

5. The method of claim 4, wherein the put price and the call price are calculated based on an at-the-money strike price.

6. The method of claim 4, wherein the put price and the call price are calculated based on a price taken from within a range that includes an at-the-money strike price.

7. The method of claim 6, wherein the range comprises a first price corresponding to about 95% of the at-the-money strike price to a second price corresponding to about 105% of the at-the-money strike price.

8. The method of claim 4, wherein the put price and the call price are calculated using a strike price different from a tradable price in the financial market.

9. The method of claim 1 comprising:
calculating, by the at least one computing device, a price of the implied volatility derivatives product as a function of the implied volatility over time.

10. The method of claim 9, comprising:
calculating a first price of the implied volatility derivatives product associated with a first time based on a first implied volatility calculated using a first risk neutral density; and
calculating a second price of the implied volatility derivatives product associated with a second time based on a second implied volatility calculated using a second risk neutral density, wherein the first risk neutral density corresponds to options information associated with the first time and the second risk neutral density corresponds to options information associated with the second time.

11. The method of claim 9, wherein calculating the price of the implied volatility derivatives product includes multiplying the implied volatility by a multiplier.

12. A non-transitory computer readable medium storing instructions that, when executed, cause at least one computing device to:
receive, via a network, options information associated with an option trading on a financial market, wherein the options information includes at least a price and a term to expiry;
calculate a risk neutral density based on the options information, wherein the risk neutral density is calculated using a technique providing a best fit for the options information; and
determine a price of an implied volatility derivatives product, the implied volatility derivatives product corresponding to implied volatility associated with the underlying financial product, wherein the price is calculated as a function of an implied volatility derived from the risk neutral density.

13. The non-transitory computer readable medium of claim 12, further comprising instructions that, when executed, cause the at least one computing device to:
identify the option on the financial market, the option having a maturity date associated with the term to expiry;
collect, at a first time, first pricing information associated with the option, wherein the option expires at the maturity date; and
collect, at a second time subsequent to the first time, second pricing information corresponding to the option that expires at the maturity date.

14. The non-transitory computer readable medium of claim 13, further comprising instructions that, when executed, cause the at least one computing device to:
calculate a first risk neutral density associated with the first time using the first pricing information;
calculate a first price of the implied volatility product associated with the first time using the first risk neutral density;
calculate a second risk neutral density using the second pricing information; and
calculate a second price of the implied volatility product associated with the second time using the second risk neutral density.

15. The non-transitory computer readable medium of claim 12, wherein the implied volatility derivatives product is associated with an option having a specified maturity date.

16. The non-transitory computer readable medium of claim 12, further comprising instructions that, when executed, cause the at least one computing device to:
identify a settlement price associated with the risk neutral density, wherein the settlement price corresponds to a price near an at-the-money strike price of the option; and
calculate an implied volatility associated with the underlying financial product using the settlement price.

17. A system comprising:
at least one computing device;
at least one non-transitory memory device communicatively coupled with the at least one computing device, wherein the at least one non-transitory memory device stores instructions that, when executed by a processor, cause the at least one computing device to:
obtain options information corresponding to an option trading at a financial exchange, wherein the options information is received at each of a plurality of times over a time period and the options information includes at least a market price, a strike price, a term to expiry, and a price of an underlier of the option;
calculate a risk neutral density based on the options information for each of the plurality of times;
determine a strike price associated with each risk neutral density at each of the plurality of times, wherein the strike price is within a range including a market price of the option;
calculate an implied volatility based on the strike price at each of the plurality of times; and
calculate a price of an implied volatility product at each of the plurality of times, the price calculated based on the implied volatility.

18. The system of claim 17, wherein the options information includes a first term to expiry and a second term to expiry, wherein the at least one non-transitory memory device stores instructions to, when executed by a processor, cause the at least one computing device to:
calculate a first price for a first implied volatility product associated with the option and corresponding to the first term to expiry; and
calculate a second price for a second implied volatility product corresponding to the option and the second term to expiry.

19. The system of claim 18, wherein a maturity date associated with the first implied volatility product and a second maturity date associated with the second implied volatility product remains fixed over a life of the first implied volatility product and a life of the second implied volatility product.

20. The system of claim 18, further comprising a communication interface communicatively coupled between the at least one computing device and a network, and wherein the instructions, when executed by a processor, cause the at least one computing device to:
query a financial exchange computing system for the options information at a nearly continuous basis.
